(19) United States
(12) Patent Application Publication
(10) Pub. No.: US 2014/0320106 A1
(43) Pub. Date: Oct. 30, 2014

(54) POWER SUPPLY CIRCUIT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: HAI-QING ZHOU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/261,531

(22) Filed: Apr. 25, 2014

(30) Foreign Application Priority Data
Apr. 29, 2013 (CN) 2013101550485

(51) Int. Cl. H02M 1/32

(52) U.S. Cl. CPC H02M 1/32
USPC 323/311

(57) ABSTRACT

A power supply circuit comprises an under voltage protection unit and a voltage conversion unit electrically connected to the under voltage protection unit. The under voltage protection unit and the voltage conversion unit are electrically connected to a power supply. When a voltage of the power supply is in a normal range, the under voltage protection unit outputs a first control signal to the voltage conversion unit. The voltage conversion unit converts the voltage of the power supply into an operation voltage, and outputs the operation voltage. When the voltage of the power supply is less than a threshold voltage, the under voltage protection unit outputs a second control signal to the voltage conversion unit, and the voltage conversion unit does not operate.

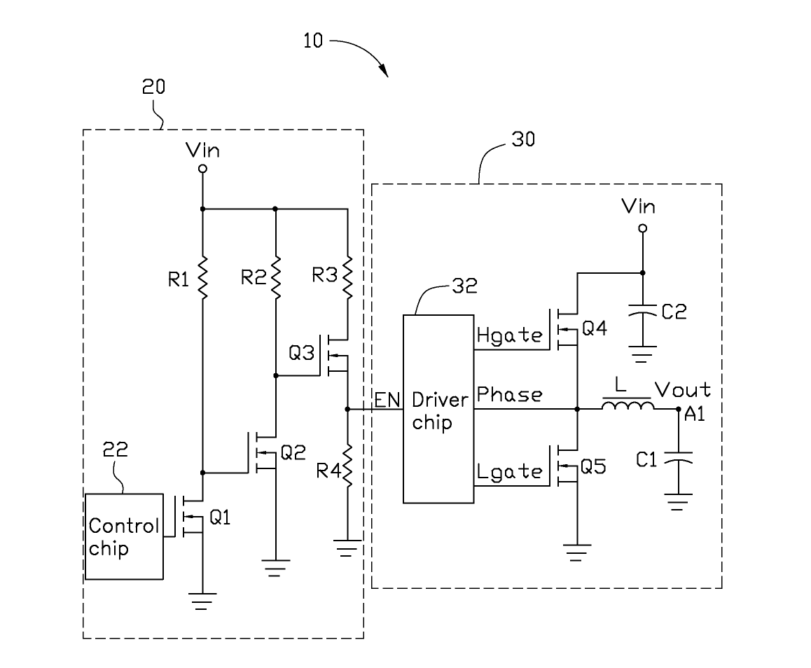

### FIELD

The present disclosure relates to a power supply circuit.

### BACKGROUND

Electronic devices, such as computers and servers, are powered by a power supply.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present embodiments.

The FIGURE is a circuit diagram of an embodiment of a power supply circuit.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references can mean “at least one.”

The FIGURE shows an embodiment of a power supply circuit 10. The power supply circuit 10 comprises an under voltage protection module 20 and a voltage conversion module 30 electrically connected to the under voltage protection module 20. The under voltage protection module 20 and the voltage conversion module 30 are electrically connected to a power supply Vin. The under voltage protection module 20 can be used for controlling the voltage conversion module 30 to operate or not, according to a voltage of the power supply Vin. The voltage conversion module 30 is used for converting the voltage of the power supply Vin into an operational voltage Vout and outputting the operational voltage Vout.

The under voltage protection module 20 comprises a control chip 22, three electronic switches Q1-Q3, and four resistors R1-R4. Each of the electronic switches Q1-Q3 comprises a first terminal, a second terminal, and a third terminal. The first terminal of the electronic switch Q1 is electrically connected to the control chip 22. The second terminal of the electronic switch Q1 is electrically coupled to the power supply Vin through the resistor R1. The third terminal of the electronic switch Q1 is electrically connected to a ground. The first terminal of the electronic switch Q2 is electrically connected to the second terminal of the electronic switch Q1. The second terminal of the electronic switch Q2 is electrically coupled to the power supply Vin through the resistor R2. The third terminal of the electronic switch Q2 is electrically connected to the ground. The first terminal of the electronic switch Q3 is electrically connected to the second terminal of the electronic switch Q2. The second terminal of the electronic switch Q3 is electrically coupled to the power supply Vin through the resistor R3. The third terminal of the electronic switch Q3 is electrically connected to the voltage conversion module 30, and electrically coupled to the ground through the resistor R4.

The voltage conversion module 30 comprises a driver chip 32, an inductor L, two capacitors C1 and C2, and two electronic switches Q4 and Q5. The driver chip 32 comprises a first control pin Hgate, a second control pin Lgate, and an enable pin EN electrically connected to the third terminal of the electronic switch Q3. Each of the electronic switches Q4 and Q5 comprises a first terminal, a second terminal, and a third terminal. The first terminal of the electronic switch Q4 is electrically connected to the first control pin Hgate of the driver chip 32. The second terminal of the electronic switch Q4 is electrically connected to the power supply Vin, and electrically coupled to the ground through the capacitor C2. The third terminal of the electronic switch Q4 is electrically coupled to the ground through the inductor L and the capacitor C1 in that order. The first terminal of the electronic switch Q5 is electrically connected to the second control pin Lgate of the driver chip 32. The second terminal of the electronic switch Q5 is electrically connected to the third terminal of the electronic switch Q4. The third terminal of the electronic switch Q5 is electrically connected to the ground. A node A1 between the inductor L and the capacitor C1 functions as the output terminal of the voltage conversion module 30, and outputs the operational voltage Vout. In at least one embodiment, the driver chip 32 operates, when a voltage of a signal received by the enable pin EN is greater than or equal to an enable voltage of the enable pin.

When the control chip 22 outputs a high-level signal, such as logic 1, to the first terminal of the electronic switch Q1, the electronic switch Q1 is turned on, the electronic switch Q2 is turned off, and the electronic switch Q3 is turned on. In this situation, the voltage of the power supply Vin is divided by the resistors R3 and R4, and a voltage at the third terminal of the electronic switch Q3 is equal to a voltage of the resistor R4.

When the electronic switch Q3 is turned on and the voltage of the power supply Vin is in a normal range, which can be for example 10.8V-13.2V, the voltage at the third terminal of the electronic switch Q3 is greater than or equal to the enable voltage of the enable pin EN, the driver chip 32 begins to operate, and the first control pin Hgate and the second control pin Lgate of the driver chip 32 alternately output high-level signals to alternately turn on the electronic switch Q4 and Q5. When the first control pin Hgate outputs a high-level signal, such as logic 1, and the second control pin Lgate outputs a low-level signal, such as logic 0, the electronic switch Q4 is turned on, and the electronic switch Q5 is turned off. The inductor L and the capacitor C1 are charged by the power supply Vin through the electronic switch Q4. When the first control pin Hgate outputs a low-level signal, and the second control pin Lgate outputs a high-level signal, the electronic switch Q4 is turned off, and the electronic switch Q5 is turned on. The inductor L and the capacitor C1 are discharged through the electronic switch Q5. The output terminal of the voltage conversion module 30 can then output the operational voltage Vout.

When the voltage of the power supply Vin is less than a threshold voltage (that is a under-voltage protection voltage), which can be for example 10.8V, because of short-circuit or other reasons, the voltage at the third terminal of the electronic switch Q3 is less than the enable voltage of the enable pin EN. The driver chip 32 does not operate, and the output terminal of the voltage conversion module 30 does not output the operational voltage Vout. Therefore, electronic devices, such as computers and servers, powered by the power supply circuit 10, will not be damaged, and an under voltage protection function of the power supply circuit 10 is achieved.

When the control chip 22 outputs a low-level signal, such as logic 0, to the first terminal of the electronic switch Q1, the electronic switch Q1 is turned off, the electronic switch Q2 is turned on, and the electronic switch Q3 is turned off. In this situation, the enable pin EN of the driver chip 32 is electrically coupled the ground through the resistor R4, and the driver chip 32 does not operate.

In at least one embodiment, each of the electronic switches Q1-Q5 can be an n-channel metal-oxide semiconductor field-effect transistor (NMOSFET), and the first terminal, the second terminal, and the third terminal of each of the electronic switches Q1-Q5 correspond to a gate, a drain, and a source of the NMOSFET, respectively. In other embodiments, each of the electronic switches Q1-Q5 may be an npn-type bipolar junction transistor or other suitable switch having similar functions.

As detailed above, the under voltage protection module 20 controls the voltage conversion module 30 to operate, when the voltage of the power supply Vin is in the normal range. And, the under voltage protection module 20 stops the voltage conversion module 30 from operating, when the voltage of the power supply Vin is less than the threshold voltage. Therefore, the under voltage protection function of the power supply circuit 10 can be achieved.

Even though numerous characteristics and advantages of the disclosure have been set forth in the foregoing description, together with details of the structure and function of the disclosure, the disclosure is illustrative only, and changes may be made in detail, including in the matters of shape, size, and arrangement of parts within the principles of the disclosure. The embodiments disclosed herein are illustrative and are not intended to be construed as limiting the following claims.

What is claimed is:

1. A power supply circuit comprising:
a voltage conversion module electrically connected to a power supply; and
an under voltage protection module comprising:
a first resistor, a second resistor, a third resistor, and a fourth resistor;
a control chip;
a first electronic switch comprising a first terminal electrically connected to the control chip, a second terminal electrically coupled to the power supply through the first resistor, and a third terminal electrically connected to a ground;
a second electronic switch comprising a first terminal electrically connected to the second terminal of the first electronic switch, a second terminal electrically coupled to the power supply through the second resistor, and a third terminal electrically connected to the ground; and
a third electronic switch comprising a first terminal electrically connected to the second terminal of the second electronic switch, a second terminal electrically coupled to the power supply through the third resistor, and a third terminal electrically connected to the voltage conversion module and electrically coupled to the ground through the fourth resistor;
wherein in response to the control chip outputting a high-level signal to the first terminal of the first electronic switch, the first electronic switch is turned on, the second electronic switch is turned off, and the third electronic switch is turned on;
wherein in response to a voltage of the power supply being in a normal range and the third electronic switch being turned on, the third terminal of the third electronic switch outputs a first control signal to the voltage conversion module, and the voltage conversion module converts the voltage of the power supply into an operational voltage and outputs the operational voltage; and
wherein in response to the voltage of the power supply being less than a threshold voltage, the third terminal of the third electronic switch outputs a second control signal to the voltage conversion module, and the voltage conversion module does not operate.

2. The power supply circuit of claim 1, wherein the voltage conversion module comprises:
an inductor;
a first capacitor;
a driver chip comprising a first control pin, a second control pin, and an enable pin electrically connected to the third terminal of the third electronic switch;
a fourth electronic switch comprising a first terminal electrically connected to the first control pin of the driver chip, a second terminal electrically connected to the power supply, and a third terminal electrically coupled to a ground through the inductor and the first capacitor in that order; and
a fifth electronic switch comprising a first terminal electrically connected to the second control pin of the driver chip, a second terminal electrically connected to the third terminal of the fourth electronic switch, and a third terminal electrically connected to a ground;
wherein a node between the inductor and the first capacitor functions as an output terminal of the voltage conversion unit;
wherein in response to the enable pin of the driver chip receiving the first control signal from the third terminal of the third electronic switch, the driver chip operates, and the output terminal of the voltage conversion unit outputs the operational voltage; and
wherein in response to the enable pin of the driver chip receiving the second control signal from the third terminal of the third electronic switch, the driver chip does not operate, and the output terminal of the voltage conversion unit does not output the operational voltage.

3. The power supply circuit of claim 2, wherein the voltage conversion module further comprises a second capacitor, the second terminal of the fourth electronic switch is electrically coupled to the ground through the second capacitor.

4. The power supply circuit of claim 3, wherein each of the fourth electronic switch and the fifth electronic switch is an n-channel metal-oxide semiconductor field-effect transistor (NMOSFET), and the first terminal, the second terminal, and the third terminal of each of the fourth electronic switch and the fifth electronic switch are respectively corresponding to a gate, a drain, and a source of the NMOSFET.

5. The power supply circuit of claim 1, wherein each of the first electronic switch, the second electronic switch, and the third electronic switch is an NMOSFET, and the first terminal, the second terminal, and the third terminal of each of the first electronic switch, the second electronic switch, and the third electronic switch are respectively corresponding to a gate, a drain, and a source of the NMOSFET.
